(19) United States
(12) Patent Application Publication
(10) Pub. No.: US 2024/0085927 A1
(43) Pub. Date: Mar. 14, 2024

(54) METHODS AND SYSTEMS FOR ADAPTIVE UAV FLIGHT CONTROLS FOR SMOOTH TRANSITIONS BETWEEN VARIOUS SPEEDS AND ACCELERATIONS

(71) Applicant: XTEND Reality Expansion Ltd., Tel Aviv (IL)

(72) Inventors: Erez Nehama, Ramat Gan (IL); Aviv Shapira, Tel Aviv (IL); Reuven Rubi Liani, Rosh Haayin (IL); Vittorio Zaidman, Rehovot (IL); Gil Danan, Tel Aviv (IL)

(73) Assignee: XTEND Reality Expansion Ltd., Tel Aviv (IL)

(21) Appl. No.: 18/367,691

(22) Filed: Sep. 13, 2023

Related U.S. Application Data
(60) Provisional application No. 63/405,949, filed on Sep. 13, 2022.

(51) Int. Cl. G05D 1/10; G05D 1/00; G05D 1/06

(52) U.S. Cl. CPC G05D 1/101; G05D 1/0088; G05D 1/0607

(57) ABSTRACT

Embodiments of the present disclosure may include a method for providing adaptive speed control of an unmanned aerial vehicle (UAV) in transitions between velocities, and between accelerations, the method includes determining an initial velocity of a UAV. Embodiments may also include detecting a change in position of a control trigger. In some embodiments, the control trigger may be operable to control acceleration of the UAV. In some embodiments, the change in position of the control trigger signals a desired positive acceleration or a desired negative acceleration of the UAV. Embodiments may also include increasing or decreasing power to one or more rotors of the UAV based on the initial velocity and the detected change in position of the trigger.

### PRIORITY CLAIM

The present application claims a priority to U.S. Provisional Patent Application No. 63/405,949 filed on Sep. 13, 2022 a disclosure of which is incorporated in its entireties by reference herein.

### FIELD OF THE INVENTION

The present application relates to unmanned aerial vehicle control methods and systems.

### BRIEF SUMMARY

Embodiments of the present disclosure may include a method for providing adaptive speed control of an unmanned aerial vehicle (UAV) in transitions between velocities, and between accelerations, the method including determining an initial velocity of a UAV. Embodiments may also include detecting a change in position of a control trigger. In some embodiments, the control trigger may be operable to control acceleration of the UAV.

In some embodiments, the change in position of the control trigger signals a desired positive acceleration or a desired negative acceleration of the UAV. Embodiments may also include increasing or decreasing power to one or more rotors of the UAV based on the initial velocity and the detected change in position of the trigger. In some embodiments, the increasing or decreasing power to one or more rotors of the UAV may be proportional to the initial velocity of the UAV and the change in position of the control trigger.

In some embodiments, the detecting a change in position of a control trigger may be carried out by a potentiometer that may be configured to translate a control trigger pressure value into an acceleration value. In some embodiments, the detecting a change in position of a control trigger may be carried out by a hall effect sensor that may be configured to translate a control trigger pressure value into an acceleration value.

In some embodiments, the increasing or decreasing power to one or more rotors of the UAV may be performed using proportional, integral, and derivative controls. In some embodiments, the increasing or decreasing power to one or more rotors of the UAV may be performed using proportional, integral, and derivative controls may be operable to at least one of a) minimize a convergence time to a target point. Embodiments may also include or b) minimize overshoot distance past a desired altitude or other target point.

In some embodiments, the method may include determining altitude error between an initial altitude and a desired altitude. Embodiments may also include determining a) an amount of power to direct to the throttle to achieve the desired altitude. Embodiments may also include b) an amount of power to direct to trimming the angle of the UAV to achieve a desired position.

In some embodiments, the increasing or decreasing power to one or more rotors of the UAV based on the initial velocity and the detected change in position of the trigger may include a virtual gear shifting mechanism. In some embodiments, the virtual gear shifting mechanism may include an infinite virtual gear shifting mechanism.

In some embodiments, the infinite virtual gear shifting mechanism may be configured to perform shifting from any position of the control trigger and from any current velocity of the UAV. In some embodiments, the automatic virtual gear shifting mechanism may be configured to calculate a new gear to apply to the UAV whenever there may be a change in position of the control trigger.

Embodiments may also include a new virtual gear may be calculated by passing a current velocity value through a linear scale from the new virtual gear's velocity range to the new virtual gear's throttle range and the new virtual gear's angles range. In some embodiments, the new virtual gear's angles range may include a roll angle range and a pitch angle range. In some embodiments, the virtual gear shifting mechanism may include an automatic virtual gear shifting mechanism.

Embodiments of the present disclosure may also include a method for maintaining smooth flight of a UAV, the method including determining a current velocity of a UAV. Embodiments may also include determining a maximum acceleration, a maximum roll angle, a maximum pitch angle, and a maximum position error gain for the current velocity of the UAV. Embodiments may also include detecting a change in position of a throttle control for the UAV.

Embodiments may also include determining whether the change in position of the throttle control exceeds a threshold value. Embodiments may also include adjusting the maximum acceleration, the maximum roll angle, the maximum pitch angle, and the maximum position error gain based on a detected change in position of the throttle control exceeding a threshold value. In some embodiments, the throttle control for the UAV may include a trigger throttle control. In some embodiments, the operations of the method may be carried out continuously.

Embodiments of the present disclosure may also include a system for providing adaptive speed control of an unmanned aerial vehicle (UAV) in transitions between velocities, and between accelerations, the system including circuitry for determining an initial velocity of a UAV. Embodiments may also include circuitry for detecting a change in position of a control trigger.

In some embodiments, the control trigger may be operable to control acceleration of the UAV. In some embodiments, the change in position of the control trigger signals a desired positive acceleration or a desired negative acceleration of the UAV. Embodiments may also include circuitry for increasing or decreasing power to one or more rotors of the UAV based on the initial velocity and the detected change in position of the trigger. In some embodiments, the circuitry for increasing or decreasing power to one or more rotors of the UAV may be proportional to the initial velocity of the UAV and the change in position of the control trigger.

In some embodiments, the circuitry for detecting a change in position of a control trigger includes at least one potentiometer that may be configured to translate a control trigger pressure value into an acceleration value. In some embodiments, the circuitry for detecting a change in position of a control trigger includes at least one hall effect sensor that may be configured to translate a control trigger pressure value into an acceleration value.

In some embodiments, the circuitry for increasing or decreasing power to one or more rotors of the UAV may be configured to use proportional, integral, and derivative controls. In some embodiments, the circuitry for increasing or decreasing power to one or more rotors of the UAV configured to use proportional, integral, and derivative controls may be operable to at least one of a) minimize a convergence time to a target point. Embodiments may also include or b) minimize overshoot distance past a desired altitude or other target point.

In some embodiments, the system may include circuitry for determining altitude error between an initial altitude and a desired altitude. Embodiments may also include circuitry for determining a) an amount of power to direct to the throttle to achieve the desired altitude. Embodiments may also include b) an amount of power to direct to trimming the angle of the UAV to achieve a desired position.

In some embodiments, the virtual gear shifting mechanism may include an automatic virtual gear shifting mechanism. In some embodiments, the automatic virtual gear shifting mechanism may be configured to calculate a new gear to apply to the UAV whenever there may be a change in position of the control trigger. Embodiments may also include a new virtual gear may be calculated by passing a current velocity value through a linear scale from the new virtual gear's velocity range to the new virtual gear's throttle range and the new virtual gear's angles range.

In some embodiments, the new virtual gear's angles range may include a roll angle range and a pitch angle range. In some embodiments, the circuitry for increasing or decreasing power to one or more rotors of the UAV based on the initial velocity and the detected change in position of the trigger may include a virtual gear shifting mechanism. In some embodiments, the virtual gear shifting mechanism may include an infinite virtual gear shifting mechanism. In some embodiments, the infinite virtual gear shifting mechanism may be configured to perform shifting from any position of the control trigger and from any current velocity of the UAV.

Embodiments of the present disclosure may also include a system for maintaining smooth flight of a UAV, the system including circuitry for determining a current velocity of a UAV. Embodiments may also include circuitry for determining a maximum acceleration, a maximum roll angle, a maximum pitch angle, and a maximum position error gain for the current velocity of the UAV.

Embodiments may also include circuitry for detecting a change in position of a throttle control for the UAV. Embodiments may also include circuitry for determining whether the change in position of the throttle control exceeds a threshold value. Embodiments may also include circuitry for adjusting the maximum acceleration, the maximum roll angle, the maximum pitch angle, and the maximum position error gain based on the change in position of the throttle control. In some embodiments, the throttle control for the UAV may include a trigger throttle control. In some embodiments, the circuitry of the system operates continuously.

Embodiments of the present disclosure may also include a computer program product including instructions which, when executed by a computer, cause the computer to carry out the following steps determining an initial velocity of a UAV. Embodiments may also include detecting a change in position of a control trigger. In some embodiments, the control trigger may be operable to control acceleration of the UAV.

In some embodiments, the change in position of the control trigger signals a desired positive acceleration or a desired negative acceleration of the UAV. Embodiments may also include increasing or decreasing power to one or more rotors of the UAV based on the initial velocity and the detected change in position of the trigger. In some embodiments, the increasing or decreasing power to one or more rotors of the UAV may be proportional to the initial velocity of the UAV and the change in position of the control trigger.

Embodiments of the present disclosure may also include a computer program product including instructions which, when executed by a computer, cause the computer to carry out the following steps determining a current velocity of a UAV. Embodiments may also include determining a maximum acceleration, a maximum roll angle, a maximum pitch angle, and a maximum position error gain for the current velocity of the UAV.

Embodiments may also include detecting a change in position of a throttle control for the UAV. Embodiments may also include determining whether the change in position of the throttle control exceeds a threshold value. Embodiments may also include adjusting the maximum acceleration, the maximum roll angle, the maximum pitch angle, and the maximum position error gain based on a detected change in position of the throttle control exceeding a threshold value.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a,’ ‘an,’ and ‘the’ include plural referents unless the context clearly dictates otherwise.

### BRIEF DESCRIPTION OF THE FIGURES

FIG. 1 depicts a drone and a controller programmed for controlled flight between low and high speeds.

FIG. 2 depicts a graph of the weight of the altitude error plotted against the altitude error itself.

FIG. 3 depicts a flow diagram of operations in the continuous monitoring of velocity and trigger position for automatic virtual gear shifting.

FIG. 4 is a flowchart illustrating a method for providing adaptive speed control of an unmanned aerial vehicle, according to some embodiments of the present disclosure.

FIG. 5 is a flowchart further illustrating the method for providing adaptive speed control of an unmanned aerial vehicle from FIG. 4, according to some embodiments of the present disclosure.

FIG. 6 is a flowchart illustrating a method for maintaining smooth flight of a UAV, according to some embodiments of the present disclosure.

FIG. 7 is a block diagram illustrating a system, according to some embodiments of the present disclosure.

FIG. 8 is a block diagram further illustrating the system from FIG. 7, according to some embodiments of the present disclosure.

FIG. 9 is a block diagram further illustrating the system from FIG. 7, according to some embodiments of the present disclosure.

FIG. 10 is a block diagram illustrating a system, according to some embodiments of the present disclosure.

FIG. 11 is a block diagram illustrating a computer program product, according to some embodiments of the present disclosure.

### DETAILED DESCRIPTION

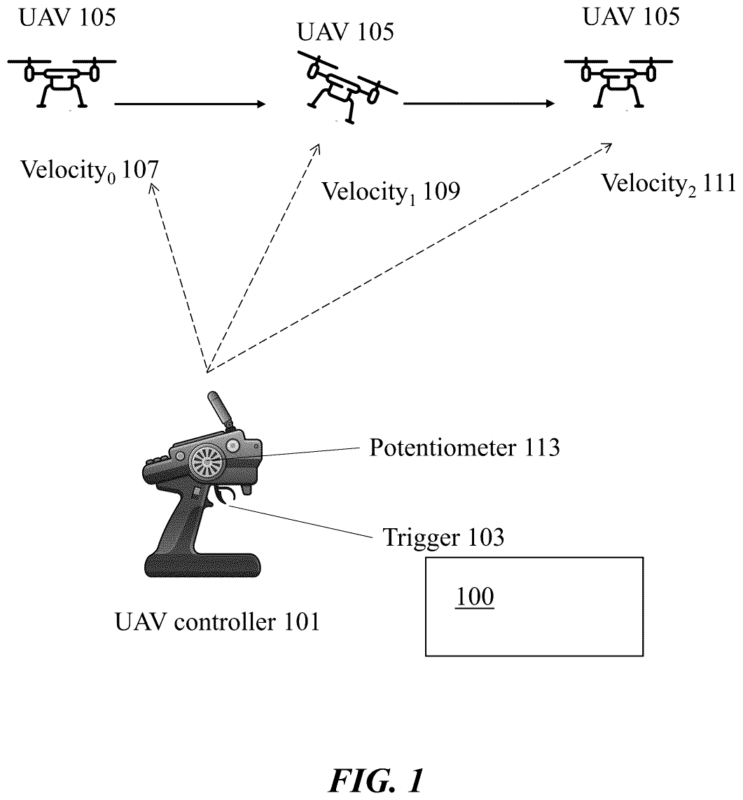

Referring to FIG. 1, in some embodiments, a UAV controller 101 having a trigger 103 is in communication with UAV 105, and the trigger controls the acceleration and deceleration of the UAV via potentiometer 113. To maintain smooth, controlled flight during high speed acceleration and deceleration, virtual gearing of the acceleration is implemented by the UAV controller or UAV, so that trigger movement at low speeds, e.g., velocity0 107, will result in proportionally less power to the rotors than the same trigger movement at high speeds, e.g., velocity1 109, giving a seamless experience of control in transitions through the entire range of UAV speeds and accelerations.

UAVs such as quadcopters are typically calibrated for a smooth flight up to a certain speed and certain angles. When the desired speeds are higher, the control system has to adapt as well. For example, when the speed of the drone 105 approaches its maximum speed, the maximum angles (e.g., roll and pitch angles) are increased as well, although larger angles translate to smaller lift force, and thus, altitude loss. Further, maximum acceleration is a second parameter that may be increased, but high acceleration at low speeds makes controlling the drone 105 difficult for the pilot. In terms of the pilot experience, it is desirable for the drone 105 to fly as smoothly at 1 km/h as at 100 km/h.

While systems 100 can adjust flight at high speeds, and adjust flight at low speeds, the present disclosure overcomes the discovery that it is a challenge for pilots to transition smoothly from low to high speeds (and vice versa) in a controlled manner.

Calculable Criteria that Affect Drone Behavior During Flight

Altitude Error Gain Modifications

Adaptive gain is calculated according to the velocity of the UAV 105 and a desired position of the UAV 105. Gain applied at low speeds is not suitable for high speeds because of the large angles necessary at high speeds—too little gain applied at high speeds results in too much altitude loss, disrupting the attainment of the desired position. The drone 105 loses vertical force to gain more horizontal speed, and it is necessary to increase the weight of the altitude error to prevent altitude loss.

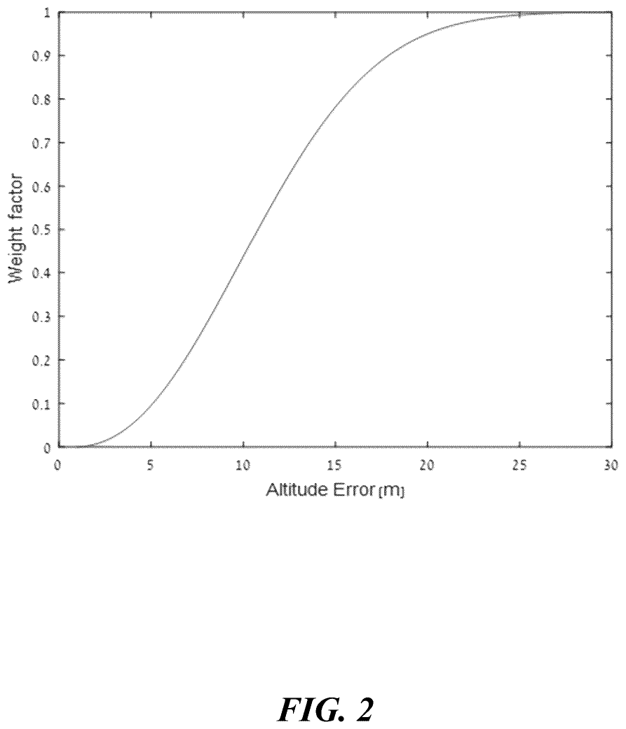

The weight of the velocity increases linearly with the increase of the velocity, while the weight of the altitude error increases exponentially with the increase of the error (FIG. 2). FIG. 2 depicts a graph of the weight of the altitude error plotted against the altitude error itself.

After calibrating the constants for each one of the variables (velocity, altitude error) we arrive at the following equation:

AltGain=OldGain+AltErrorWeight·C1+VelErrorWeight·C2+FastTriggerRelease
Where:
e=DesiredAlt−Alt;
AltErrorWeight=−0.0002978·e3+0.009291·e2−0.02065·e
VelErrorWeight=Total3DSpeed−C3Speed; and
FastTriggerRelease=C4

AltGain=OldGain+AltErrorWeight·C₁+VelErrorWeight·C₂+FastTrigger Release
Where:
e=DesiredAlt−Alt;
AltErrorWeight=−0.0002978·e³+0.009291·e²−0.02065·e
VelErrorWeight=Total3DSpeed−C₃Speed; and
FastTriggerRelease=C₄

This new “AltGain” is suitable for high speeds, but it is also needed when braking from high speed to low speed. Large errors are created when trying to decrease momentum from 120 km/h high speed flight, and it is necessary to maintain the new gain although the velocity is reduced, and the error might be small. If the high gain is not maintained, the altitude error will increase rapidly.

The function EX_isConvergFromHighSpeed ( ) is meant to identify the above situations and determine if it is necessary to use the increased gain according to the velocity, trigger position, marker position (e.g., a desired position marker in mark and fly systems), altitude error, and the state of flight. In cases where there is still a use for the larger gain, an internal timer determines if the gain may be reduced at some subsequent point in time, or stay at its current (larger) value.

The equation above is most relevant to fast trigger release (discussed below) and the proportional, integral, and derivative (PID) controls changes associated with maintaining the desired altitude of the drone and still brake with respect to the operator. The equation uses the altitude error between the desired and the current altitude to understand how much of the gain should be towards the throttle, which will resolve the altitude of the drone, and how much will be directed towards the attitudinal angles of the drone, which will resolve the position of the drone. These limits contribute to keeping the operator relaxed and informed with a smooth view of the horizon or other target view.

In some embodiments, increasing or decreasing power to one or more rotors of the UAV is performed using proportional, integral, and derivative controls to minimize a convergence time to a target point; minimize overshoot distance past a desired altitude or other target point; or both. In other words, tuning the PID controls maximizes speed to a target point and minimizes error in reaching the target point.

Fast Trigger Release

The controller's trigger is used both for “gas” and “brakes” in the piloted system, that is, for both acceleration and deceleration (e.g., negative acceleration with positive velocity) of the UAV. When a UAV operator releases the trigger rapidly, the pilot is communicating an instruction to the drone to interpret the release as a “stop now,” even though slowing of the UAV is best effected by releasing the trigger slowly, just like one tries to not slam on the brakes in a car if it is not an emergency. It is a goal of the present system to augment the pilot's actions by translating these actions into instructions to be executed by the UAV.

A similar situation involves an “Abort” command that may be sent from a ground control station, or GCS. When the controller receives the order to stop or Abort, it calculates a reasonable position of the stop according to the current velocity.

The desired position to stop and hold should be far enough ahead of the UAV to lose the momentum of the high-speed flight while retaining the smooth flight experience of the operator (e.g., no sudden changes, no drastic angles, clean forward facing sight, etc.). To make this happen, the instant system limits the position error gain, the acceleration, and the maximum angles. In this system of controlled flight, it is not enough to extend the stopping distance because it will cause the UAV to gain even more speed (e.g., if the desired position is set to a far distant location). Limiting the rates and maximum values of the drone after identifying the situation is the key.

Virtual Automatic Transmission

The transition between velocities described above allows for seamless and automatic virtual gearing between low speeds and high speeds. Let us call the maximum acceleration, maximum angles, and maximum position error gain our “power.” Increasing the limits generates more power, and decreasing the limits restricts our power.

To reach higher velocities we need extra power, and if we have the maximum power, we will not have very much control over the drone at low speeds, like a bull in a china shop. The position of the trigger sets the first virtual gear and from this point the operator has the same “power” for movement in a defined region of the trigger. When pressing or releasing the trigger beyond this region, the system shifts the virtual gear up or down, respectively, and thus adjusts the desired power.

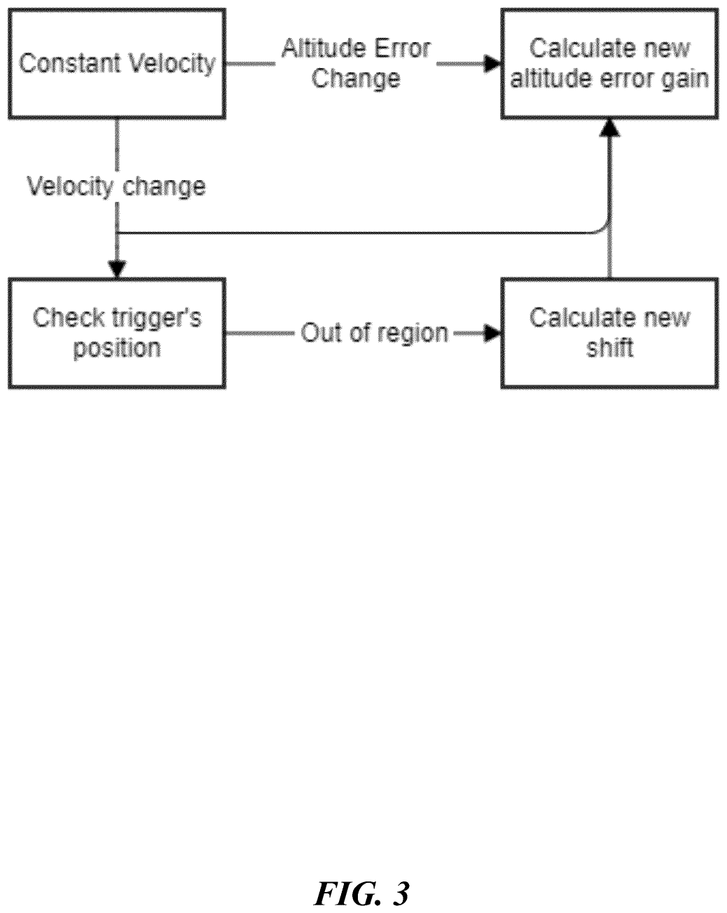

To maintain smooth flight, the virtual gear is determined by the velocity of the drone continuously, so if the virtual gear shifts upward while the UAV is flying at 80 km/h, it will add more power than if the virtual gear shifts upward while the UAV is flying at 79 km/h. There are no predefined velocities for each virtual gear. See FIG. 3, which depicts a flow diagram of operations in the continuous monitoring of velocity and trigger position for automatic virtual gear shifting.

When shifting to a new higher virtual gear, this results in higher acceleration, and higher acceleration results in higher or new altitude error gain, which in turn results in higher PIDs, all different PIDs, depending on the shift. This of course is initiated by movement of the trigger, which is detected by sensors inside the controller. For example, linear or logarithmic potentiometers may be used to detect trigger position movements over time during operation of the UAV. In other embodiments, a hall effect sensor may be used to detect movement of the trigger, alone or in combination with a potentiometer. A Hall effect sensor, or just Hall sensor, is a type of sensor that detects the presence and magnitude of a magnetic field using the Hall effect. The output voltage of a Hall sensor is directly proportional to the strength of the detected magnetic field.

In some embodiments, automatic shifting is accomplished by calculating a new gear when the trigger is out of the region of the previous gear. The new gear is calculated by passing the current velocity through a linear scale from the defined gear's velocity range to the gear's throttle range and the gear's angles (roll, pitch) range.

In some embodiments, the virtual gear shifting mechanism comprises an infinite virtual gear shifting mechanism. For example, an infinite virtual gear shifting mechanism may be configured to perform shifting from any position of the control trigger and from any current velocity of the UAV. In some embodiments, the gear shifting is not limited to a range of velocities, e.g., 11-20 kph, then shift to 21-30 kph as the next gear. Instead, the virtual gearing described and claimed herein can proceed from any velocity to any subsequent velocity.

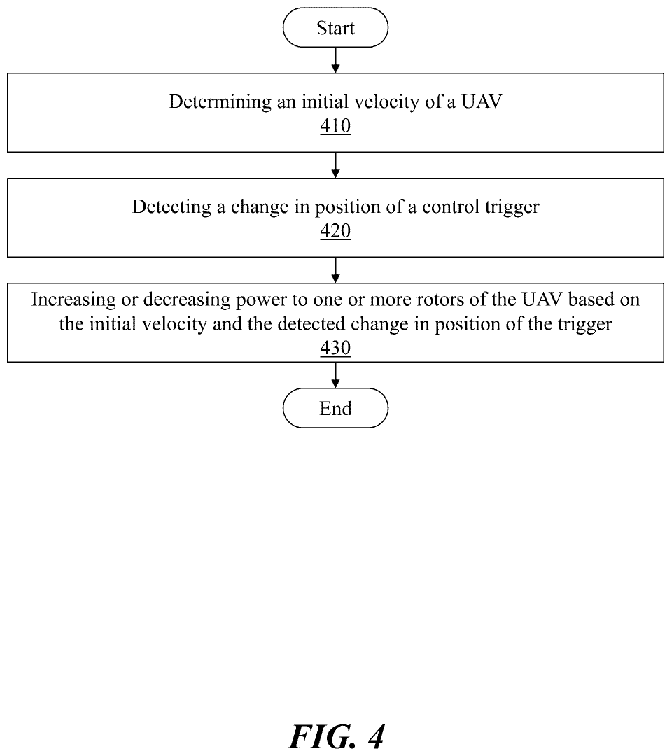

FIG. 4 is a flowchart that describes a method for providing adaptive speed control of an unmanned aerial vehicle, according to some embodiments of the present disclosure. In some embodiments, at 410, the method may include determining an initial velocity of a UAV. At 420, the method may include detecting a change in position of a control trigger. At 430, the method may include increasing or decreasing power to one or more rotors of the UAV based on the initial velocity and the detected change in position of the trigger. The control trigger may be operable to control acceleration of the UAV. The change in position of the control trigger signals a desired positive acceleration or a desired negative acceleration of the UAV. The increasing or decreasing power to one or more rotors of the UAV may be proportional to the initial velocity of the UAV and the change in position of the control trigger.

In some embodiments, the method depicted in FIG. 4 adaptively modulates the speed of an unmanned aerial vehicle (UAV) through an interaction between the initial velocity and the control trigger's positional change. In particular, the adaptive speed control system employs a multi-step approach that initially ascertains the UAV's baseline speed or initial velocity at step 410. This baseline data serves as a reference point for subsequent calculations. Next, at step 420, the system remains vigilant for any alterations in the control trigger's position, which serves as an indicator of the operator's intent to either accelerate or decelerate the UAV.

Once such a change is detected, the system then computes the necessary power adjustments to the UAV's rotors at step 430. This power modulation is carefully calibrated to be proportional to both the initial velocity and the magnitude of the trigger's positional change. In doing so, the method allows for smoother transitions in speed, thereby minimizing abrupt changes that could destabilize the UAV. The control trigger's role is pivotal, as it not only influences the speed but does so in a way that is sensitive to the UAV's existing velocity. This holistic approach ensures a more nuanced and responsive control mechanism for UAV speed regulation.

In some embodiments, the detecting a change in position of a control trigger may be carried out by a potentiometer that may be configured to translate a control trigger pressure value into an acceleration value. In some embodiments, the detecting a change in position of a control trigger may be carried out by a hall effect sensor that may be configured to translate a control trigger pressure value into an acceleration value.

In some embodiments, the increasing or decreasing power to one or more rotors of the UAV may be performed using proportional, integral, and derivative controls. In some embodiments, the increasing or decreasing power to one or more rotors of the UAV may be performed using proportional, integral, and derivative controls may be operable to at least one of minimize a convergence time to a target point or minimize overshoot distance past a desired altitude or other target point.

In some embodiments, the aforementioned control methodology may further include the system's use of Proportional, Integral, and Derivative (PID) controls to offer a high degree of precision and responsiveness. In essence, PID controls contribute to three key aspects of system behavior: immediate error correction (Proportional), cumulative error correction over time (Integral), and predictive error adjustment based on rate of error change (Derivative). When applied to the modulation of rotor power, these PID controls serve dual purposes. First, they can significantly minimize the convergence time to a designated target point, ensuring that the UAV reaches its intended altitude, position, or velocity in the most efficient manner possible while under pilot control. Second, PID controls can also actively minimize any overshoot distance past a desired target point or altitude, thus enhancing the UAV's operational safety and accuracy.

By integrating PID controls in the described adaptive speed control mechanism, the system can adapt to a wide range of operational scenarios, from rapid ascents to controlled descents, without sacrificing stability. This dynamic approach permits more than just simple proportional adjustments based on initial velocity and trigger position; it allows for a nuanced, multi-dimensional control strategy that accounts for past, present, and future states to achieve optimal performance. Therefore, the PID controls add an additional layer of complexity and capability to the adaptive speed control method, making it a robust solution for a diverse set of UAV applications.

In some embodiments, the increasing or decreasing power to one or more rotors of the UAV based on the initial velocity and the detected change in position of the trigger may comprise a virtual gear shifting mechanism. In some embodiments, the virtual gear shifting mechanism may comprise an infinite virtual gear shifting mechanism. In some embodiments, the infinite virtual gear shifting mechanism may be configured to perform shifting from any position of the control trigger and from any current velocity of the UAV. Further delving into the intricacies of the adaptive speed control system, the concept of a ‘virtual gear shifting mechanism’ emerges as a notable feature, elevating the control sophistication. Unlike traditional mechanical gear systems that are limited by predefined stages, the virtual gear shifting mechanism in this system offers a continuous, or ‘infinite,’ range of gear ratios. This infinite virtual gear shifting capability allows for highly nuanced control over the UAV's speed and power distribution to its rotors.

In practical terms, the mechanism is not constrained by preset configurations and can adapt dynamically based on real-time parameters such as the current velocity of the UAV and pilot interaction with the UAV control (e.g., the control trigger's position). The UAV operator, therefore, has the ability to shift gears virtually at any point, regardless of the UAV's current speed or control trigger position. This opens up a number of operational advantages. For instance, immediate shifts can be made to respond to sudden changes in wind speed or direction, obstacles in the UAV's path, or rapid changes in altitude requirements. By enabling shifting from any position of the control trigger and from any current velocity of the UAV, the infinite virtual gear shifting mechanism lends an unprecedented level of agility and responsiveness to the UAV's adaptive speed control system, thereby enhancing its overall performance and operational versatility.

In some embodiments, the automatic virtual gear shifting mechanism may be configured to calculate a new gear to apply to the UAV whenever there may be a change in position of the control trigger. In some embodiments, a new virtual gear may be calculated by passing a current velocity value through a linear scale from the new virtual gear's velocity range to the new virtual gear's throttle range and the new virtual gear's angles range. In some embodiments, the new virtual gear's angles range may comprise a roll angle range and a pitch angle range. In some embodiments, the virtual gear shifting mechanism may comprise an automatic virtual gear shifting mechanism.

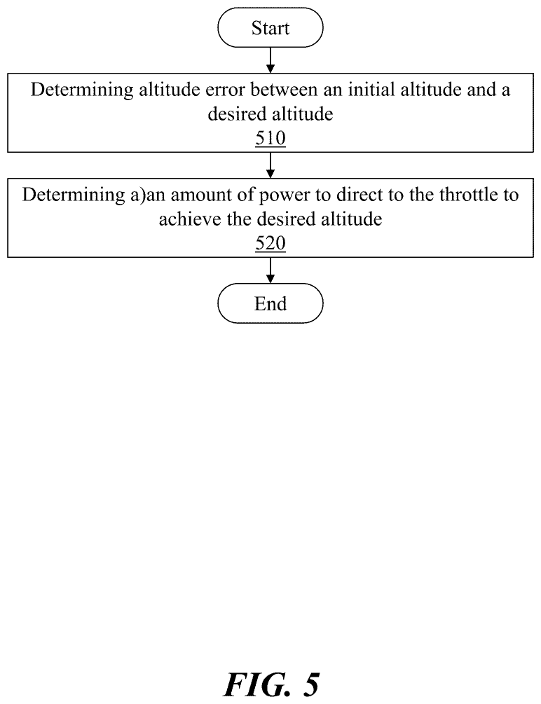

FIG. 5 is a flowchart that further describes the method for providing adaptive speed control of an unmanned aerial vehicle from FIG. 4, according to some embodiments of the present disclosure. In some embodiments, at 510, the method may include determining altitude error between an initial altitude and a desired altitude. At 520, the method may include determining a) an amount of power to direct to the throttle to achieve the desired altitude and/or b) an amount of power to direct to trimming the angle of the UAV to achieve a desired position.

Building upon the foundation discussed in FIG. 4, in some embodiments FIG. 5 introduces additional layers of control and adaptability, specifically focusing on the UAV's altitude and positional adjustments. At step 510, the method first establishes an ‘altitude error,’ which in some embodiments is the difference between the UAV's current altitude and the target or desired altitude. This altitude error or deviation serves a role analogous to the initial velocity discussed in FIG. 4, acting as a critical reference point for ensuing calculations and adjustments.

In some embodiments, once the altitude error is ascertained, the method proceeds to step 520, where it bifurcates into two potential pathways for control adjustments. The first pathway (520a) involves computing the requisite amount of power to channel to the throttle to reach the desired altitude. Much like the power adjustments to the rotors in FIG. 4, in some embodiments this calculated throttle power aims to bring the UAV to the intended altitude while accounting for the initial altitude error. The throttle adjustment may engage similar control mechanisms, such as PID controls, to ensure minimal convergence time and overshoot.

In some embodiments, the second pathway at step 520 (520b) may be centered around achieving a specific spatial position for the UAV by altering its angle or orientation. Here, the method may calculate the precise amount of power needed for ‘trimming the angle’ of the UAV. Trimming in this context means finely tuning the UAV's orientation to ensure it aligns perfectly with the intended direction or target point identified by the pilot. This angle adjustment can be particularly useful in scenarios requiring high precision, such as search and rescue operations, non-destructive testing, or detailed surveying.

In some embodiments, the method of FIG. 5 enriches the adaptive speed control framework initially laid out in FIG. 4 by adding an altitude- and position-focused dimension. By incorporating these aspects, the method may become even more versatile and capable of addressing a broader range of operational needs. Whether it's rapid altitude changes or subtle repositioning, the method described in FIG. 5 supports the pilot in navigating these complexities with accuracy and efficiency, thus offering a more comprehensive solution for UAV navigation and control.

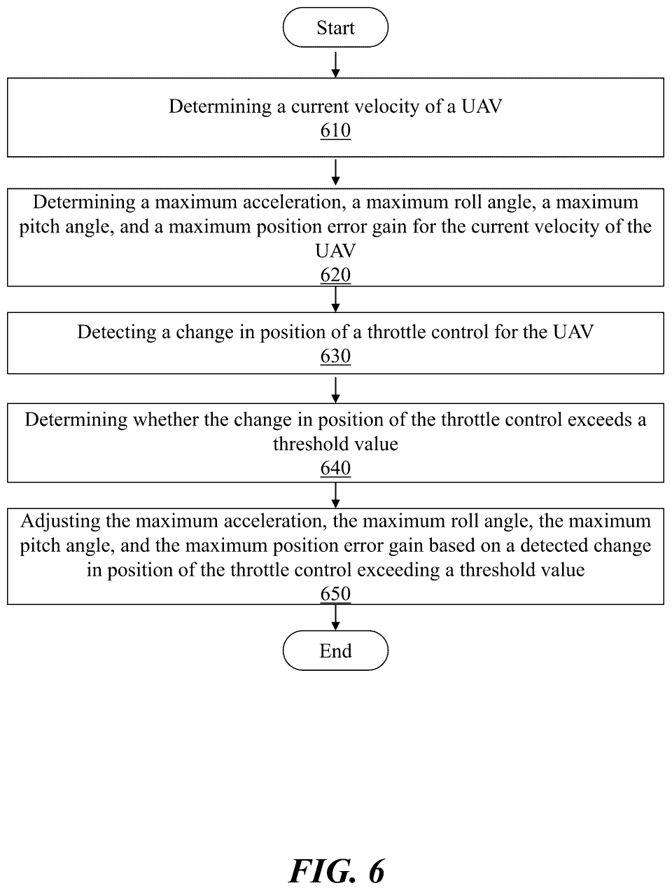

FIG. 6 is a flowchart that describes a method for maintaining smooth flight of a UAV, according to some embodiments of the present disclosure. In some embodiments, at 610, the method may include determining a current velocity of a UAV. At 620, the method may include determining a maximum acceleration, a maximum roll angle, a maximum pitch angle, and a maximum position error gain for the current velocity of the UAV. At 630, the method may include detecting a change in position of a throttle control for the UAV. At 640, the method may include determining whether the change in position of the throttle control exceeds a threshold value. At 650, the method may include adjusting the maximum acceleration, the maximum roll angle, the maximum pitch angle, and the maximum position error gain based on a detected change in position of the throttle control exceeding a threshold value. In some embodiments, the throttle control for the UAV may comprise a trigger throttle control. In some embodiments, the operations of the method may be carried out continuously.

In some embodiments, the adaptive control strategies described in FIG. 6 may provide a comprehensive method for ensuring the piloted UAV's flight remains smooth and stable across different environmental conditions. In some embodiments, the method may provide the pilot with nuanced management of several flight parameters simultaneously, demonstrating a higher level of control in real-time. At step 610, much like the initial velocity in FIG. 4 and the altitude error in FIG. 5, the method may begin by capturing the UAV's current velocity as the initial operation, followed by subsequent calculations.

Moving to step 620, the method may determine not just one, but four flight parameters: maximum acceleration, maximum roll angle, maximum pitch angle, and maximum position error gain. These parameters are individually tailored based on the UAV's current velocity, highlighting a synergistic relationship between pilot controlled speed and stability factors of the UAV.

At step 630, the method may further provide a system monitoring loop to detect any changes in the position of the UAV's throttle control, which could be implemented as a trigger throttle control for enhanced ergonomics and intuitive user interface. Upon identifying such a change, the method at step 640 may evaluate whether this deviation crosses a predetermined threshold value, serving as a filtering mechanism to isolate significant input changes from minor, inadvertent movements. When such a threshold is exceeded, step 650 may become activated, and the method recalibrates the previously determined maximum values for acceleration, roll angle, pitch angle, and position error gain. This recalibration may be used to adapt to the new throttle control position, thereby offering a harmonized flight response that considers both the UAV's existing momentum and the pilot's latest input.

In some embodiments, all these operations can be carried out continuously, ensuring that the UAV remains in a state of optimal responsiveness and stability throughout its flight. This continuous adjustment provides a dynamic layer of protection against abrupt changes in flight conditions or sudden operator inputs, as an addition to the overarching framework for advanced piloted UAV control.

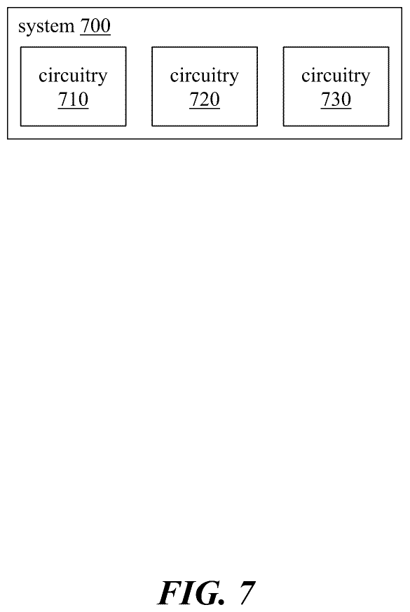

FIG. 7 is a block diagram that describes a system 700, according to some embodiments of the present disclosure. In some embodiments, the system 700 may include circuitry 710 for determining an initial velocity of a UAV, circuitry 720 for detecting a change in position of a control trigger, and circuitry 730 for increasing or decreasing power to one or more rotors of the UAV based on the initial velocity and the detected change in position of the trigger. The control trigger may be operable to control acceleration of the UAV. The change in position of the control trigger signals a desired positive acceleration or a desired negative acceleration of the UAV. The circuitry 730 for increasing or decreasing power to one or more rotors of the UAV may be proportional to the initial velocity of the UAV and the change in position of the control trigger.

In some embodiments, circuitry 730 is responsible for detecting shifts in the position of a control trigger. Moreover, this same circuitry 730 is also designed to modulate the power supplied to one or more rotors of the UAV. The modulation of rotor power in the circuitry 730 may employ Proportional, Integral, and Derivative (PID) controls for enhanced precision and responsiveness. Specifically, when utilizing PID controls, circuitry 730 can achieve one or more of the following objectives: a) reducing the time required for the UAV to reach a specified target point, or b) limiting the overshoot distance when the UAV passes a predetermined altitude or other designated target point.

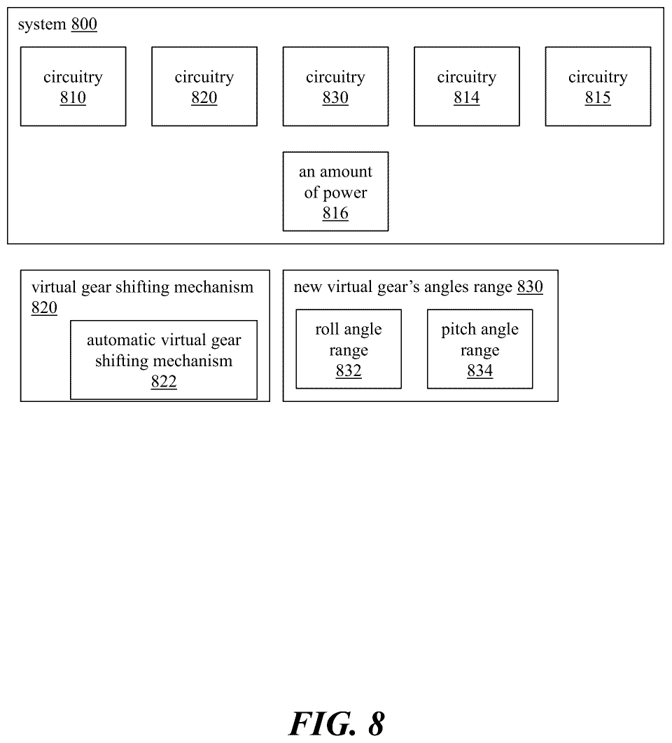

FIG. 8 is a block diagram that further describes system 700 from FIG. 7, according to some embodiments of the present disclosure. In some embodiments, system 700 may include circuitry 814 that may be tasked with determining an altitude error. This altitude error may be defined as the difference between the initial and desired altitudes of the UAV. Additionally, in some embodiments, circuitry 815 may be configured to perform dual functions: a) it may determine the amount of power to be directed to the throttle for the purpose of achieving the desired altitude, and b) it may collaborate with circuitry 816 to calculate the level of power needed for angle adjustments, thus facilitating the UAV's alignment to a specified spatial orientation desired by the pilot.

System 700 may also incorporate a virtual gear shifting mechanism, identified as element 820. In some embodiments, this mechanism may include an automatic variant, referred to as automatic virtual gear shifting mechanism 822. This automatic variant may be configured to continually reassess and adapt new virtual gears based on any observed changes in the position of the control trigger. When in operation, the automatic virtual gear shifting mechanism 822 may use the UAV's current velocity as an input parameter. This parameter may then be subjected to a linear scaling algorithm, which may map it onto new virtual gear's designated velocity range, throttle range, and angular range. The new virtual gear's angular range, indicated as element 830 in some embodiments, may comprise sub-ranges specifically for roll angle and pitch angle, further designated as elements 832 and 834, respectively. These sub-ranges may offer the system granular control over the UAV's spatial orientation. This may enable precise adjustments in both the roll and pitch dimensions, thereby providing a robust framework for the adaptive and nuanced control of the UAV.

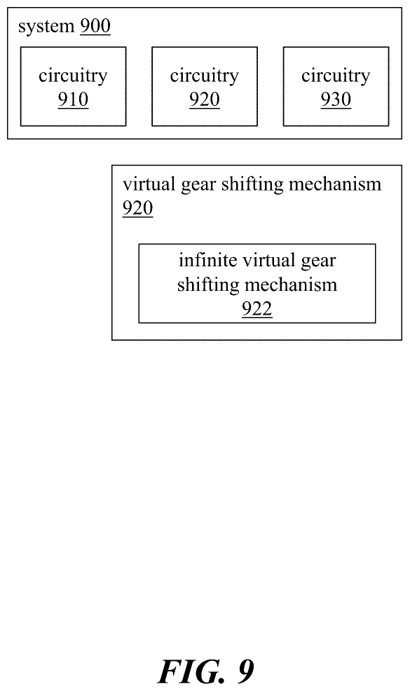

FIG. 9 is a block diagram that further describes the system 700 from FIG. 7, according to some embodiments of the present disclosure. In some embodiments, the circuitry 730 for increasing or decreasing power to one or more rotors of the UAV based on the initial velocity and the detected change in position of the trigger. In some embodiments, the virtual gear shifting mechanism 920 may include an infinite virtual gear shifting mechanism 922. In some embodiments, the infinite virtual gear shifting mechanism 922 may be configured to perform shifting from any position of the control trigger and from any current velocity of the UAV.

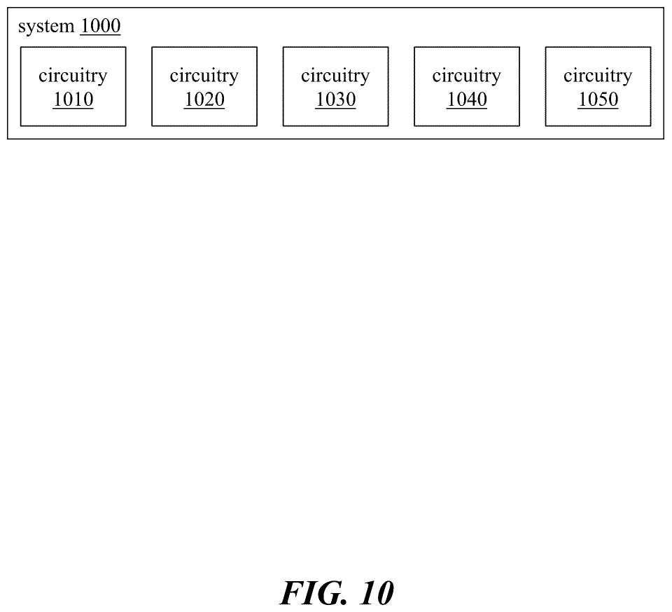

FIG. 10 is a block diagram that describes a system 1000, according to some embodiments of the present disclosure. In some embodiments, the system 1000 may include circuitry 1010 for determining a current velocity of a UAV, circuitry 1030 for detecting a change in position of a throttle control for the UAV, and circuitry 1040 for determining whether the change in position of the throttle control exceeds a threshold value. The system 1000 may also include circuitry 1020 for determining a maximum acceleration, a maximum roll angle, a maximum pitch angle, and a maximum position error gain for the current velocity of the UAV. The system 1000 may also include circuitry 1050 for adjusting the maximum acceleration, the maximum roll angle, the maximum pitch angle, and the maximum position error gain based on the change in position of the throttle control. In some embodiments, the throttle control for the UAV. In some embodiments, the circuitry 1050 of the system 1000 may operate continuously.

In some embodiments, system 1000 of FIG. 10 may serve as an advanced control framework for piloted UAV operation, incorporating multiple specialized circuitries for various functionalities. In some embodiments, circuitry 1010 for determining the current velocity of a UAV may include a suite of sensors such as a GPS module, an inertial measurement unit (IMU), and a speedometer. These sensors may work in tandem to provide a precise and real-time velocity reading of the UAV.

In some embodiments, circuitry 1020 may be tasked with determining a variety of maximum allowable parameters including maximum acceleration, roll angle, pitch angle, and position error gain for the UAV at its current velocity. In some embodiments, this circuitry may incorporate accelerometers and gyroscopes to measure and define these upper limits, factoring in data such as wind speed, payload, and existing power levels to calculate these maximums dynamically.

In some embodiments, circuitry 1030 for detecting a change in the position of the throttle control may include a combination of potentiometers and rotary encoders that can gauge the displacement and orientation of the throttle control with high accuracy. These components may serve as the basis for user input, capturing even subtle adjustments in the control position.

In some embodiments, circuitry 1040 may be specialized for assessing whether any changes in the throttle control position surpass a predetermined threshold value. In some embodiments, this circuitry may use analog-to-digital converters to quantify the magnitude of the throttle adjustments and compare it against a stored threshold. Conditional logic circuits may also be employed to determine if the change should initiate a response from other components within the system.

In some embodiments, circuitry 1050 may be responsible for adjusting the maximum acceleration, roll angle, pitch angle, and position error gain, based on detected changes in the position of the throttle control. In some embodiments, this circuitry may include programmable logic controllers (PLCs) or microcontrollers that receive input from other circuitries and execute control algorithms to modify these maximum parameters. Feedback loops may be integrated into this circuitry to allow continuous adjustment based on real-time conditions.

In some embodiments, the throttle control serves as a crucial component of the human-machine interface that facilitates UAV operation. This interface may not only be onboard the UAV but also be part of a ground-based or remote control unit that communicates wirelessly with the UAV. The circuitry 1050, whether housed within the UAV or on separate hardware, is designed to function continuously. This ongoing operation ensures that the UAV can adapt in real-time to dynamic changes in flight conditions and instantaneous inputs from the operator, thereby augmenting the system's reliability and responsiveness. In some embodiments, the system 1000 maintains a bi-directional communication link with both the UAV and the pilot's control interface. This link could be established through various wireless communication protocols, such as Wi-Fi, LTE, or dedicated radio frequencies. In these embodiments, system 1000 is configured to receive a wealth of sensor data from the UAV, encompassing metrics like altitude, velocity, and geographic position. Additionally, it may also receive input from the control interface, which could include the throttle setting, roll, pitch, and yaw commands. Based on this multifaceted data input, system 1000 can execute complex calculations and control algorithms, like those discussed in relation to FIG. 4, FIG. 5, and FIG. 6.

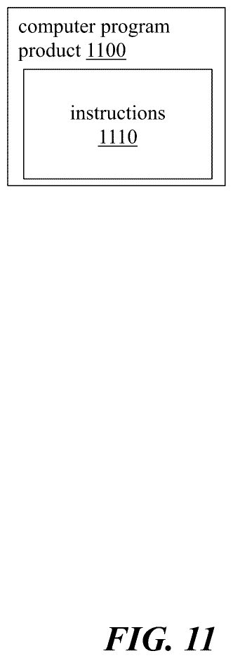

FIG. 11 is a block diagram that describes a computer program product 1100, according to some embodiments of the present disclosure. In some embodiments, the computer program product 1100 may include a set of comprehensive instructions 1110. When executed by a computer, these instructions may cause the computer to carry out a series of interrelated tasks encompassing various aspects of UAV control and dynamics.

The instructions may include, among other things, determining the initial velocity of a UAV. This initial velocity may serve as a reference point for various downstream calculations and control operations. In some embodiments, the control trigger may be operable to manage the acceleration of the UAV. The change in the position of this control trigger may signal either a desired positive acceleration or a desired negative acceleration of the UAV.

Furthermore, the instructions may also guide the computer in increasing or decreasing the power to one or more rotors of the UAV based on both the initial and current velocities, as well as detected changes in the position of the control trigger. In some embodiments, this power modulation to the rotors may be proportionate to these velocities and the change in position of the control trigger.

In addition to the above functionalities, the instructions may include determining a current velocity of the UAV, establishing maximum allowable parameters such as maximum acceleration, roll angle, pitch angle, and position error gain for this current velocity. Detecting changes in the position of a throttle control may also be part of the task list, along with ascertaining whether such changes exceed a predefined threshold value. In instances where the changes do exceed this threshold, the instructions may direct the computer to adjust these maximum parameters accordingly.

By incorporating these features, the computer program product 1100 may provide a more comprehensive, nuanced, and responsive control mechanism that considers both initial conditions and real-time changes in control inputs and UAV dynamics. This integrated approach achieves seamless piloted flight control, thereby enhancing the UAV's operational efficiency and safety.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having ordinary skill in the art will recognize that the state of the art has progressed to the point where there is little distinction left between hardware, software, and/or firmware implementations of aspects of systems; the use of hardware, software, and/or firmware is generally a design choice representing cost vs. efficiency tradeoffs (but not always, in that in certain contexts the choice between hardware and software can become significant). Those having ordinary skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

In some implementations described herein, logic and similar implementations may include software or other control structures suitable to operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise controlling special-purpose components. Specifications or other implementations may be transmitted by one or more instances of tangible or transitory transmission media as described herein, optionally by packet transmission or otherwise by passing through distributed media at various times.

Alternatively or additionally, implementations may include executing a special-purpose instruction sequence or otherwise operating circuitry for enabling, triggering, coordinating, requesting, or otherwise causing one or more occurrences of any functional operations described above. In some variants, operational or other logical descriptions herein may be expressed directly as source code and compiled or otherwise expressed as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar modes of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those having ordinary skill in the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a USB drive, a solid state memory device, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read-only, etc.)), and/or electrical circuitry forming a communications device (e.g., a modem, communications switch, optical-electrical equipment, etc.). Those having ordinary skill in the art will recognize that the subject matter described herein may be implemented in an analog or digital fashion or some combination thereof.

Those skilled in the art will recognize that at least a portion of the devices and/or processes described herein can be integrated into a data processing system. Those having ordinary skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

In certain cases, use of a system or method as disclosed and claimed herein may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory.

Further, implementation of at least part of a system for performing a method in one territory does not preclude use of the system in another territory.

Any U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., operations), devices, objects, and the discussion accompanying them are used as examples for the sake of conceptual clarity and that various configuration modifications are contemplated. Consequently, as used herein, the specific examples set forth and the accompanying discussion are intended to be representative of their more general classes. In general, use of any specific example is intended to be representative of its class, and the non-inclusion of specific components (e.g., operations), devices, and objects should not be taken to be limiting.

With respect to the use of substantially any plural and/or singular terms herein, those having ordinary skill in the art can translate from the plural to the singular or from the singular to the plural as is appropriate to the context or application. The various singular/plural permutations are not expressly set forth herein for sake of clarity.

The herein described subject matter sometimes illustrates different components contained within, or connected with, different other components. It is to be understood that such depicted architectures are presented merely as examples, and that in fact many other architectures may be implemented which achieve the same functionality. In a conceptual sense, any arrangement of components to achieve the same functionality is effectively “associated” such that the desired functionality is achieved. Therefore, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of “operably couplable” include but are not limited to physically mateable or physically interacting components, wirelessly interactable components, wirelessly interacting components, logically interacting components, or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such a recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having ordinary skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having ordinary skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented as sequences of operations, it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method for providing adaptive speed control of an unmanned aerial vehicle (UAV) in transitions between velocities, and between accelerations, the method comprising:
determining an initial velocity of a UAV;
detecting a change in position of a control trigger, wherein the control trigger is operable to control acceleration of the UAV, and wherein the change in position of the control trigger signals a desired positive acceleration or a desired negative acceleration of the UAV; and
increasing or decreasing power to one or more rotors of the UAV based on the initial velocity and the detected change in position of the trigger, wherein the increasing or decreasing power to one or more rotors of the UAV is proportional to the initial velocity of the UAV and the change in position of the control trigger.

2. The method of claim 1, wherein the detecting a change in position of a control trigger is carried out by a potentiometer that is configured to translate a control trigger pressure value into an acceleration value.

3. The method of claim 1, wherein the detecting a change in position of a control trigger is carried out by a hall effect sensor that is configured to translate a control trigger pressure value into an acceleration value.

4. The method of claim 1, wherein the increasing or decreasing power to one or more rotors of the UAV is performed using proportional, integral, and derivative controls.

5. The method of claim 4, wherein the increasing or decreasing power to one or more rotors of the UAV is performed using proportional, integral, and derivative controls is operable to at least one of a) minimize a convergence time to a target point; or b) minimize overshoot distance past a desired altitude or other target point.

6. The method of claim 1, further comprising:
determining altitude error between an initial altitude and a desired altitude; and
determining a) an amount of power to direct to the throttle to achieve the desired altitude; and b) an amount of power to direct to trimming the angle of the UAV to achieve a desired position.

7. The method of claim 1, wherein the increasing or decreasing power to one or more rotors of the UAV based on the initial velocity and the detected change in position of the trigger comprises a virtual gear shifting mechanism.

8. The method of claim 7, wherein the virtual gear shifting mechanism comprises an infinite virtual gear shifting mechanism.

9. The method of claim 8, wherein the infinite virtual gear shifting mechanism is configured to perform shifting from any position of the control trigger and from any current velocity of the UAV.

10. The method of claim 7, wherein the virtual gear shifting mechanism comprises an automatic virtual gear shifting mechanism.

11. The method of claim 8, wherein the automatic virtual gear shifting mechanism is configured to calculate a new gear to apply to the UAV whenever there is a change in position of the control trigger.

12. The method of claim 11, wherein a new virtual gear is calculated by passing a current velocity value through a linear scale from the new virtual gear's velocity range to the new virtual gear's throttle range and the new virtual gear's angles range.

13. The method of claim 12, wherein the new virtual gear's angles range comprises a roll angle range and a pitch angle range.

14. A method for maintaining smooth flight of a UAV, the method comprising:
determining a current velocity of a UAV;
determining a maximum acceleration, a maximum roll angle, a maximum pitch angle, and a maximum position error gain for the current velocity of the UAV;
detecting a change in position of a throttle control for the UAV;
determining whether the change in position of the throttle control exceeds a threshold value; and
adjusting the maximum acceleration, the maximum roll angle, the maximum pitch angle, and the maximum position error gain based on a detected change in position of the throttle control exceeding a threshold value.

15. The method of claim 14, wherein the throttle control for the UAV comprises a trigger throttle control.

16. The method of claim 14, wherein the operations of the method are carried out continuously.

17. A system for providing adaptive speed control of an unmanned aerial vehicle (UAV) in transitions between velocities, and between accelerations, the system comprising:
circuitry for determining an initial velocity of a UAV;
circuitry for detecting a change in position of a control trigger, wherein the control trigger is operable to control acceleration of the UAV, and wherein the change in position of the control trigger signals a desired positive acceleration or a desired negative acceleration of the UAV; and
circuitry for increasing or decreasing power to one or more rotors of the UAV based on the initial velocity and the detected change in position of the trigger, wherein the circuitry for increasing or decreasing power to one or more rotors of the UAV is proportional to the initial velocity of the UAV and the change in position of the control trigger.

18. The system of claim 17, wherein the circuitry for detecting a change in position of a control trigger includes at least one potentiometer that is configured to translate a control trigger pressure value into an acceleration value.

19. The system of claim 17, wherein the circuitry for detecting a change in position of a control trigger includes at least one hall effect sensor that is configured to translate a control trigger pressure value into an acceleration value.

20. The system of claim 17, wherein the circuitry for increasing or decreasing power to one or more rotors of the UAV is configured to use proportional, integral, and derivative controls.

21. The system of claim 20, wherein the circuitry for increasing or decreasing power to one or more rotors of the UAV configured to use proportional, integral, and derivative controls is operable to at least one of a) minimize a convergence time to a target point; or b) minimize overshoot distance past a desired altitude or other target point.

22. The system of claim 17, further comprising:
circuitry for determining altitude error between an initial altitude and a desired altitude; and
circuitry for determining a) an amount of power to direct to the throttle to achieve the desired altitude; and b) an amount of power to direct to trimming the angle of the UAV to achieve a desired position.

23. The system of claim 17, wherein the circuitry for increasing or decreasing power to one or more rotors of the UAV based on the initial velocity and the detected change in position of the trigger comprises a virtual gear shifting mechanism.

24. The system of claim 23, wherein the virtual gear shifting mechanism comprises an infinite virtual gear shifting mechanism.

25. The system of claim 24, wherein the infinite virtual gear shifting mechanism is configured to perform shifting from any position of the control trigger and from any current velocity of the UAV.

26. The system of claim 22, wherein the virtual gear shifting mechanism comprises an automatic virtual gear shifting mechanism.

27. The system of claim 26, wherein the automatic virtual gear shifting mechanism is configured to calculate a new gear to apply to the UAV whenever there is a change in position of the control trigger.

28. The system of claim 27, wherein a new virtual gear is calculated by passing a current velocity value through a linear scale from the new virtual gear's velocity range to the new virtual gear's throttle range and the new virtual gear's angles range.

29. The system of claim 28, wherein the new virtual gear's angles range comprises a roll angle range and a pitch angle range.

30. A system for maintaining smooth flight of a UAV, the system comprising:
circuitry for determining a current velocity of a UAV;
circuitry for determining a maximum acceleration, a maximum roll angle, a maximum pitch angle, and a maximum position error gain for the current velocity of the UAV;
circuitry for detecting a change in position of a throttle control for the UAV;
circuitry for determining whether the change in position of the throttle control exceeds a threshold value; and
circuitry for adjusting the maximum acceleration, the maximum roll angle, the maximum pitch angle, and the maximum position error gain based on the change in position of the throttle control.

31. The system of claim 30, wherein the throttle control for the UAV comprises a trigger throttle control.

32. The system of claim 30, wherein the circuitry of the system operates continuously.

33. A computer program product comprising instructions which, when executed by a computer, cause the computer to carry out the following steps:
determining an initial velocity of a UAV;
detecting a change in position of a control trigger, wherein the control trigger is operable to control acceleration of the UAV, and wherein the change in position of the control trigger signals a desired positive acceleration or a desired negative acceleration of the UAV; and
increasing or decreasing power to one or more rotors of the UAV based on the initial velocity and the detected change in position of the trigger, wherein the increasing or decreasing power to one or more rotors of the UAV is proportional to the initial velocity of the UAV and the change in position of the control trigger.

34. A computer program product comprising instructions which, when executed by a computer, cause the computer to carry out the following steps:
determining a current velocity of a UAV;
determining a maximum acceleration, a maximum roll angle, a maximum pitch angle, and a maximum position error gain for the current velocity of the UAV;
detecting a change in position of a throttle control for the UAV;
determining whether the change in position of the throttle control exceeds a threshold value; and
adjusting the maximum acceleration, the maximum roll angle, the maximum pitch angle, and the maximum position error gain based on a detected change in position of the throttle control exceeding a threshold value.
